(19) United States
(12) Patent Application Publication
(10) Pub. No.: US 2026/0063159 A1
(43) Pub. Date: Mar. 5, 2026

(54) Self-Locking Fastener

(71) Applicant: Illinois Tool Works Inc., Glenview, IL (US)

(72) Inventors: Lovisa E. M. Rodriguez, Homewood, IL (US); Kileean E. Bell, Monee, IL (US); Joel R. Lee, Peotone, IL (US)

(21) Appl. No.: 19/305,500

(22) Filed: Aug. 20, 2025

Related U.S. Application Data
(60) Provisional application No. 63/689,076, filed on Aug. 30, 2024.

(51) Int. Cl. F16B 21/08; F16B 19/10

(52) U.S. Cl. CPC F16B 21/086; F16B 19/1081

(57) ABSTRACT

A fastener to connect a first component to a second component with an opening. The fastener includes a head with two lock tabs, each shaped with a sloped sidewall, and a lead-in portion that fits into the opening. A shank connects the lead-in portion to a push bar, which has at least one angled (chamfered) edge. Flexible legs extend between the head and the lead-in portion and compress as the lead-in portion is inserted. During installation, the chamfered edge of the push bar slides against the sloped sidewall of the lock tabs, allowing the push bar to move past them. Once in place, the lock tabs hold the push bar, keeping the flexible legs compressed and locking the fastener securely.

### CROSS-REFERENCE

The present application claims priority to United States Provisional Ser. No. 63/689,076 , filed Aug. 30, 2024, and entitled “Self-Locking Fastener,” which is hereby incorporated by reference in its entirety.

### BACKGROUND

Automotive components require fastening solutions that are simple to manufacture and assemble, yet highly reliable and efficient. To secure a secondary panel to a primary panel, fasteners are commonly used. For example, commonly-owned U.S. Pat. No. 6,652,206 describes a rivet-type fastener for panel and other hole-retention applications, in which insertion expands the arms to secure the fastener and engages post protrusions with arm notches to lock it in place. In some cases, fasteners engage with openings in one or both panels, which may vary in shape-such as slots or holes-or in size due to manufacturing tolerances. Despite advancements, there remains a need for a fastener that can reliably fit holes with large tolerances and install in a single step.

### SUMMARY

The present disclosure relates generally to a fastening system and fastener to form a connection between components, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a, 1b, and 1c illustrate, respectively, disassembled, partially assembly, and fully assembled side views of an example fastening system configured to form a connection between components in accordance with aspects of this disclosure.

FIG. 1d illustrates a detailed side view of the lock tabs of the fastener.

FIG. 1e illustrates a detailed side view of the push bar of the fastener.

FIG. 1f illustrates a detailed side view of the head portion of the fastener.

FIG. 2a illustrates an underside isometric view of the fastener in accordance with an aspect of this disclosure.

FIG. 2b illustrates a topside isometric view of the fastener in accordance with an aspect of this disclosure.

FIG. 2c illustrates a first elevational side view of the fastener.

FIG. 2d illustrates a second elevational side view of the fastener.

FIG. 2e illustrates a third elevational side view of the fastener, while FIG. 2f illustrates a cross-sectional elevational side view thereof taken along cutline A-A (FIG. 2j).

FIG. 2g illustrates a fourth elevational side view of the fastener, while FIG. 2h illustrates a cross-sectional elevational side view thereof taken along cutline B-B (FIG. 2j).

FIG. 2i illustrates a top plan view of the fastener.

FIG. 2j illustrates a bottom plan view of the fastener.

FIG. 2k illustrates a top plan view of the fastener taken along cutline C-C (FIG. 2g)

FIG. 2l illustrates a topside isometric view of the fastener taken along cutline C-C (FIG. 2g).

FIG. 3 illustrates a side view of an example routing clip in accordance with aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener having head and retention portions can be used to form a connection between a first component and a second component, such as automotive panels. The disclosed fastener is configured to be installed in a single step while accommodating openings having relatively large tolerances (e.g., greater than 1 mm). During insertion, interaction between the panel and a push bar causes the push bar to be displaced upward as a downward force is applied to the fastener. This displacement induces bending of resilient legs (e.g., flexible legs) from an initial substantially vertical orientation toward a substantially horizontal orientation. In the horizontal orientation, the resilient legs extend beyond the maximum dimension of the opening to generate an upward clamping force beneath the panel. In certain embodiments, the fastener further includes an umbrella portion or flexible arms disposed above the panel to provide a supplemental downward clamping force. As the fastener approaches its fully installed position, locking features between the head portion and the retention portion to retain the resilient legs in the deflected state, thereby preventing withdrawal of the fastener and securing the panel connection. Therefore, unlike existing fastener that require a second step for install or require small tolerances, the disclosed fastener provides increased tolerance capabilities and the single step motion via a single fastener.

In one example, a fastener for coupling a first component to a second component having an opening comprises: a head portion configured to couple with the first component, the head portion including a pair of lock tabs, each lock tab having a sloped sidewall; a lead-in portion configured for insertion through the opening; a shank extending from the lead-in portion; a push bar coupled to the shank, the push bar having at least one chamfered edge; and a pair of resilient legs extending between the head portion and the lead-in portion, the resilient legs being configured to compress into a deflected state as the lead-in portion passes through the opening; wherein the at least one chamfered edge of the push bar is configured to engage the sloped sidewall of at least one lock tab to allow the push bar to pass between the lock tabs during assembly, and wherein the lock tabs are configured to capture the push bar after passage between the pair of lock tabs, thereby securing the resilient legs in the deflected state.

In another example, a fastener for coupling a first component to a second component having an opening comprises: a head portion configured to couple with the first component, the head portion including a pair of lock tabs; a lead-in portion configured for insertion through the opening; a push bar coupled to a shank extending from the lead-in portion; and a pair of resilient legs extending between the head portion and the lead-in portion, the resilient legs being configured to compress into a deflected state as the lead-in portion passes through the opening; wherein the lock tabs are configured to capture the push bar after insertion, thereby securing the resilient legs in the deflected state.

In some examples, the push bar comprises an elongated structure oriented substantially perpendicular to the shank.

In some examples, the push bar comprises an elongated structure having at least one chamfered edge along its length, the chamfered edge being configured to engage at least one of the lock tabs during assembly.

In some examples, the push bar comprises an elongated structure having a pair of chamfered edges along its length, the chamfered edges being configured to engage at least one of the lock tabs during assembly.

In some examples, each of the lock tabs comprises a sloped sidewall configured to engage the push bar during assembly.

In some examples, the lock tabs are offset relative to one another.

In some examples, each of the resilient legs comprises a first segment coupled to a second segment by a hinge.

In yet another example, a fastener for coupling a first component to a second component having an opening comprises: a head portion configured to couple with the first component, the head portion including a first lock feature; a lead-in portion configured for insertion through the opening; a second lock feature coupled to the lead-in portion; and a pair of resilient legs extending between the head portion and the lead-in portion, the resilient legs being configured to compress into a deflected state as the lead-in portion passes through the opening; wherein the second lock feature is configured to couple with the first lock feature to secure the resilient legs in the deflected state.

In some examples, the second lock feature comprises a push bar.

In some examples, the push bar is coupled to the lead-in portion via a shank.

In some examples, the push bar comprises an elongated structure oriented substantially perpendicular to the shank.

In some examples, the push bar is configured to engage the opening to fix the lead-in portion relative to the second component during installation while the resilient legs continue to compress.

In some examples, the first lock feature comprises one or more lock tabs.

In some examples, each of the one or more lock tabs is coupled to the head portion via a standoff.

In some examples, the first lock feature comprises a pair of lock tabs.

In some examples, each of the pair of lock tabs is offset relative to one another.

In some examples, each of the pair of resilient legs comprises a first segment coupled to a second segment via a hinge.

In some examples, the resilient legs are configured, when installed, to press against the first component to generate a spring force that maintains compression.

In some examples, the head portion is configured to couple with the first component via a doghouse feature.

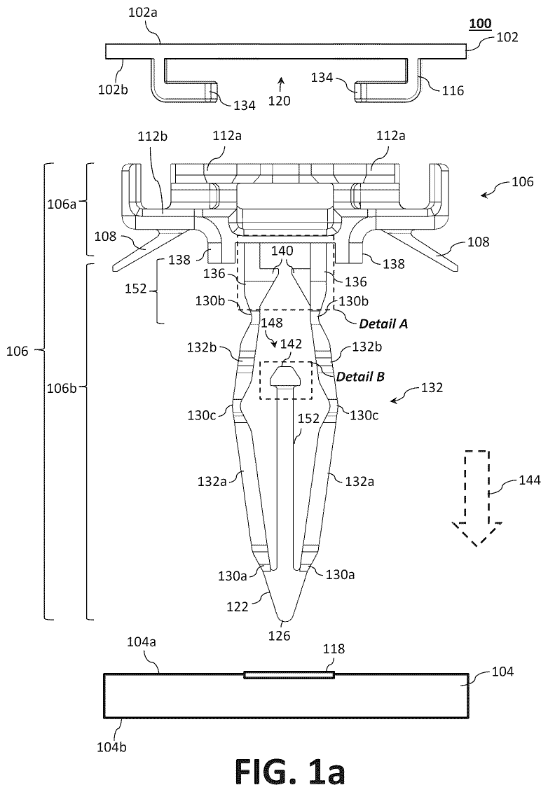

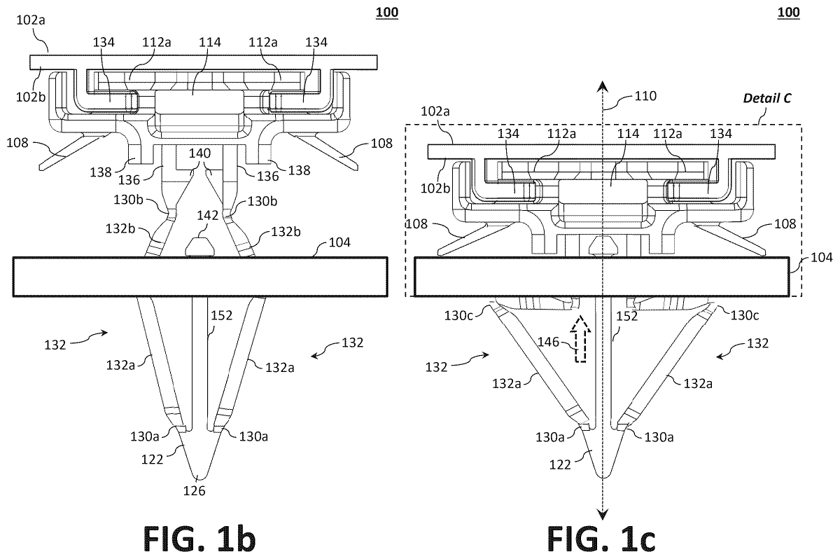

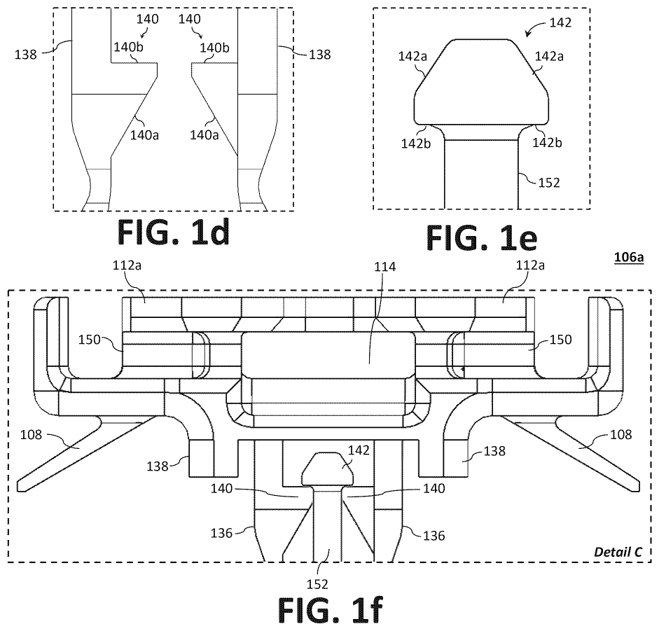

FIGS. 1a, 1b, and 1c illustrate, respectively, disassembled, partially assembly, and fully assembled side views of an example fastening system 100 configured to form a connection between a first component 102 and a second component 104. The fastening system 100 generally comprises the first component 102, the second component 104, and a fastener 106, where the fastener 106 is configured to be installed in a single step.

The fastener 106 includes a head portion 106a and a retention portion 106b joined to one another by resilient legs 132. The fastener 106 includes a pair of locking features between the head portion 106a and the retention portion 106b to retain the resilient legs 132 in the deflected state (e.g., an assembled position). The pair of locking features can include a first lock feature such as lock tabs 140 and a second lock feature such as a push bar 142. FIG. 1d illustrates a detailed side view of the lock tabs 140 of the fastener 106, while FIG. 1e illustrates a detailed side view of the push bar 142 of the fastener 106 and FIG. 1f illustrates a detailed side view of the head portion of the fastener 106 in an assembled position. For illustrative purposes, the first component 102 and the second component 104 are omitted from FIG. 1f.

The first component 102 and the second component 104 may be, for example, automotive panels. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, door trim panels, moldings, trim pieces, and other substrates (whether used as interior or exterior surfaces).

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features. In the illustrated example, the first component 102 defines a doghouse feature 116, while the second component 104 defines an opening 118 (e.g., holes, windows, or cutouts).

The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. The second component 104 may define an A-surface 104a and a B-surface 104b (illustrated as an undersurface). Upon assembly, as best illustrated in FIG. 1b, the second component 104 is covered at least partially by the first component 102.

As illustrated, the fastener 106 is attached to the B-surface 102b of the first component 102 and, depending on the material type, may be attached to the B-surface 102b after fabrication of the first component 102 (e.g., using adhesive or a mechanical attachment method, such as the illustrated doghouse feature 116). While only a single fastener 106 is illustrated in the examples, it should be appreciated that multiple fasteners 106 may be used to couple the first component 102 to the second component 104, depending on the number of fastener points needed between the first component 102 and second component 104. For example, larger panels typically require multiple fastener points.

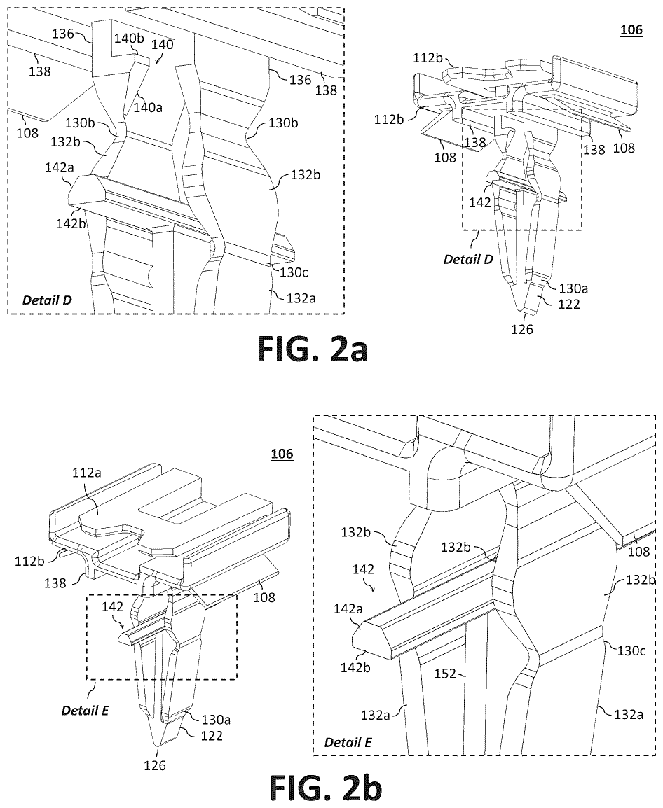

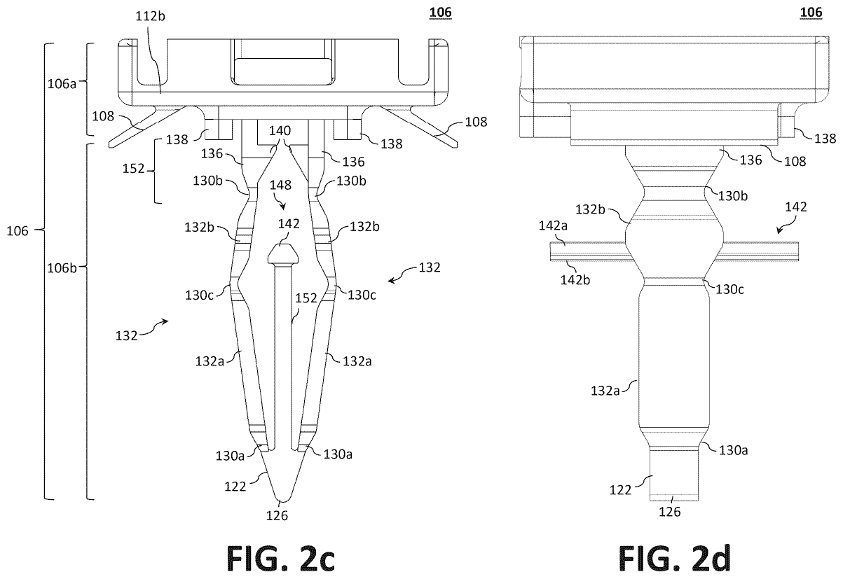

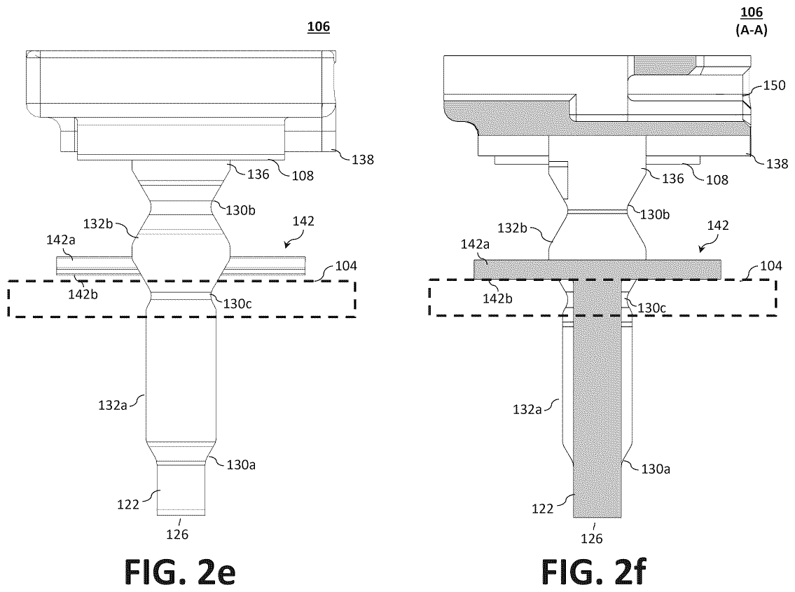

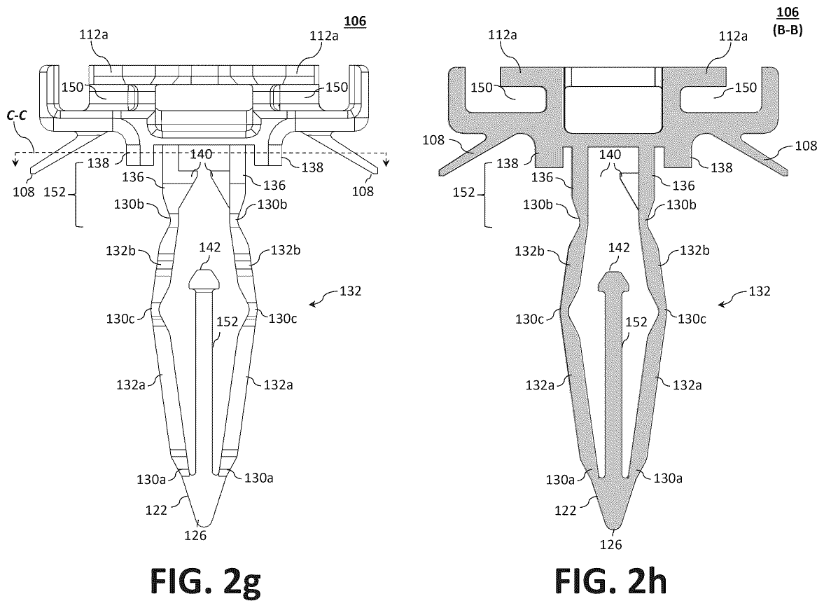

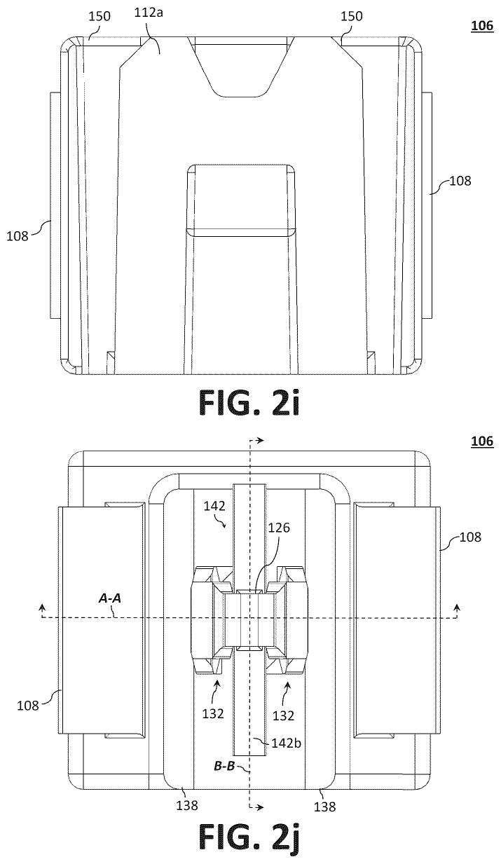

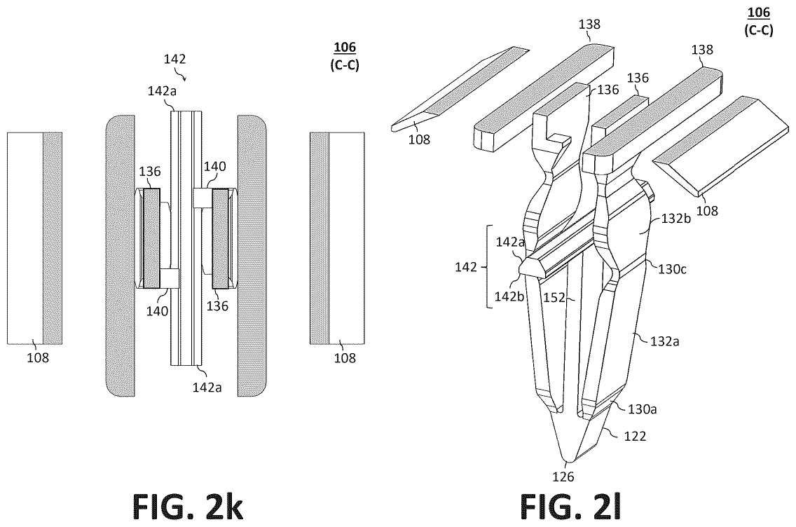

FIG. 2a illustrates an underside isometric view of the fastener 106 in accordance with an aspect of this disclosure. FIG. 2b illustrates a topside isometric view of the fastener 106 in accordance with an aspect of this disclosure. FIGS. 2c and 2d illustrate, respectively, first and second elevational side views of the fastener 106. FIG. 2e illustrates a third elevational side view of the fastener 106, while FIG. 2f illustrates a cross-sectional elevational side view thereof taken along cutline A-A (FIG. 2j). FIG. 2g illustrates a fourth elevational side view of the fastener 106, while FIG. 2h illustrates a cross-sectional elevational side view thereof taken along cutline B-B (FIG. 2j). FIGS. 2i and 2j illustrate, respectively, top and bottom plan views of the fastener 106. FIG. 2k illustrates a top plan view of the fastener 106 taken along cutline C-C (FIG. 2g), while FIG. 2l illustrates a topside isometric view of the fastener 106 taken along cutline C-C (FIG. 2g).

The fastener 106 is a generally rigid component that generally defines the head portion 106a and the retention portion 106b, which extends away from the head portion 106a along a center axis 110. As can be appreciated, the fastener 106 is configured to define a retention zone 152 between or adjacent the retention portion 106b and the head portion 106a to engage and securely retain the second component 104 to thereby facilitate a reliable connection between the first component 102 and the second component 104. In some examples, a pair of wings 108 (or an umbrella, collar, or the like) is positioned between the head portion 106a and the retention portion 106b to provide a supplemental downward clamping force to the fastening system 100. The head portion 106a can be formed integrally with the retention portion 106b and, where applicable, the pair of wings 108 or other features.

The head portion 106a is configured to engage or otherwise attach to the first component 102. In the illustrated example, the head portion 106a generally defines a set of spaced-apart components (illustrated as first plate portion 112a and a second plate portion 112b) separated by a neck 114 (or another spacer). The spaced-apart components define a gap or pocket 150. The dimensions and thickness of the spaced-apart components may be adjusted to accommodate varying load requirements or space constraints.

The illustrated head portion 106a therefore comprises the first plate portion 112a and the second plate portion 112b, connected by the neck 114 to define the gap or pocket 150 between the first plate portion 112a and the second plate portion 112b. The neck 114 extends between and integrally connects the first plate portion 112a to the second plate portion 112b. The illustrated neck 114 is cylindrical and ensures spacing between the first plate portion 112a to the second plate portion 112b to accommodate features of the first component 102, such as the doghouse feature 116. The illustrated neck 114 is aligned along the center axis 110, which can also serve as the central axis for the overall fastener 106.

During assembly, the fastener 106 is attached to the first component 102 by sliding the head portion 106a into a cavity 120 defined by a doghouse feature 116. The doghouse feature 116 includes a pair of spaced-apart sidewalls with engagement dogs 134 configured to retain the head portion 106a. For example, the engagement dogs 134 can slip into the gap or pocket 150. This attachment ensures that the fastener remains securely in place during alignment with the second component 104. The first plate portion 112a and the second plate portion 112b are, therefore, sized and shaped such that the second plate portion 112b fits in the cavity 120. Next, the first component 102, with the attached fastener 106, is aligned relative to the second component 104 such that the lead-in portion 126 (e.g., a lead-in nose) aligns with an opening 118 in the second component. The opening 118 may be a slot, a round hole, or any other compatible shape.

While illustrated as configured for use with the doghouse feature 116, the doghouse feature 116, the second plate portion 112b, and/or the neck 114 could be omitted and the fastener 106, or portion thereof, can be attached to or integrated with the first component via another means. For example, the head portion 106a can be adhesively secured to the first component 102. In another example, the first component 102 and the fastener 106 may be formed as a unitary structure. Therefore, while the present disclosure will be generally described in connection with a doghouse feature 116, the teachings of the present disclosure, such as those directed to the retention portion 106b may be applied to other types of fasteners where installation via a single step while accommodating openings 118 having relatively large tolerances is desired.

The retention portion 106b is configured to engage or otherwise attach to the second component 104. The retention portion 106b is configured to pass through at least a portion of the second component 104 (e.g., via the opening 118) and attach to the second component 104. The opening 118 formed in the second component 104 defines a size and shape that is complementary to that of the retention portion 106b such that the retention portion 106b can be inserted and retained therein. In an example, the opening 118 can be generally circular (e.g., a round hole) and/or a slot (e.g., a narrow, rectangular opening), though other shapes are contemplated, including quadrilateral, oval, rectangular, and square openings.

The retention portion 106b is coupled to and extends downward from the underside of the head portion 106a. The illustrated retention portion 106b includes a lead-in portion 126, a capture assembly 148, and a pair of resilient legs 132 resiliently coupled to and extending between the head portion 106a and the lead-in portion 126. In the illustrated example, the capture assembly 148 comprises a push bar 142 that is coupled to the lead-in portion 126 via a shank 152.

The lead-in portion 126 can be conical, beveled, sloped, or otherwise tapered at its distal end to facilitate alignment during insertion into the opening 118. The lead-in portion 126 serves as a guide for the fastener during engagement, while the shaft portion 128 helps to ensure secure attachment between the head section 106a and the lead-in portion 126. In some examples, the central stem 122 can provide additional structural bracing to mitigate deformation of the retention portion 106b during installation and maintain alignment with the center axis 110.

The illustrated lead-in portion 126 is spaced apart from the head portion 106a and connected thereto by the pair of resilient legs 132. The push bar 142 is disposed between the head portion 106a and the lead-in portion 126, and between the resilient legs 132, and may be centrally aligned between the resilient legs 132 in certain aspects. The shank 152 extends upward from the lead-in portion 126 (e.g., toward the head portion 106a), generally along the center axis 110, and the push bar 142 is arranged perpendicular to the shank 152 such that it extends outwardly away from the shank 152. This arrangement enables the push bar 142 to engage the opening 118 and subsequently snap or lock with the lock tabs 140.

During installation, for example, the resilient legs 132 are resiliently biased toward the B-side surface 104b of the second component 104. When the fastener 106 is inserted and pushed through the opening 118 of the second component 104, in the direction as indicated by arrow 144, the capture assembly 148 engages the opening 118, causing the resilient legs 132 to compress against the second component 104. For example, the push bar 142 can be configured as an elongated structure with a length that is greater than the width of the opening 118, thereby preventing the push bar 142 from passing through the opening 118 during assembly.

Because the push bar 142 cannot pass through the opening 118, the capture assembly 148 and the lead-in portion 126 become fixed (e.g., stationary) relative to the second component 104, while the resilient legs 132 compress to enable the head portion 106a to continue moving in the direction indicated by arrow 144. The capture assembly 148 effectively moves closer to the head portion 106a as indicated by arrow 146 until a portion of the capture assembly 148 engages and locks with the head portion 106a. In other words, during installation, the push bar 142 is configured to catch the opening 118 and then pass beyond the lock tabs 140 to secure with (e.g., clip or snap to) the lock tabs 140.

With reference to FIGS. 1c and 1f, the push bar 142 is urged between and passes beyond a pair of lock tabs 140. The pair of lock tabs 140 are resiliently coupled to, or formed within, the head portion 106a to allow the push bar 142 to pass therebetween. In the illustrated example, the head portion 106a defines a pair of linear standoffs 136 (e.g., a pair of spaced apart wall) and one or more stabilizing shoulders 138. The pair of lock tabs 140 can be formed in or on the standoffs 136 and oriented generally toward each other or the center axis 110. The standoffs 136 can be sized depending on an intended thickness for the second component 104 The shoulders 138 serve to mitigate movement (e.g., side-to-side movement) after assembly be increasing the contact area between the fastener and the second component 104.

With reference to FIG. 2k, the pair of lock tabs 140 may be offset relative to one another to reduce insertion forces, for example by permitting the push bar 142 to twist or rotate as it passes the lock tabs 140. While two lock tabs 140 are shown, any number of lock tabs 140 may be used depending on factors such as desired locking strength or the size of the fastener 106. In some embodiments, the lock tabs 140 may be aligned rather than offset. In other embodiments, the lock tabs 140 may extend across a greater portion of the standoff 136 width. For instance, while the illustrated lock tab 140 spans less than one-quarter of the width of the standoff 136, it may instead span more than one-quarter, more than one-third, more than one-half, or even the entire width of the standoff 136.

Once the push bar 142 passes beyond the pair of lock tabs 140, the lock tabs 140 return to their default position to secure the push bar 142 of the capture assembly 148 (and the lead-in portion 126) in place, thereby maintaining the resilient legs 132 in a compressed state to secure the first component 102 and the second component 104 to one another. The resilient legs 132 also generate a spring force that maintains consistent panel compression. This design effectively reduces or eliminates gaps that may lead to buzz, squeak, and rattle (BSR) issues.

The geometries of the lock tabs 140 and the push bar 142 can be configured to reduce insertion force during assembly while maintaining a strong post-assembly connection. For example, with reference to FIG. 1d and 1e, each of the lock tabs 140 and the push bar 142 includes one or more angled surfaces that engage one another during assembly to minimize insertion forces. The lock tabs 140, as illustrated in FIG. 1d, can be provided as generally triangular structures (that is, a triangular side profile or cross-section) with at least one angled or sloped sidewall 140a (or beveled, rounded, etc.) and a flat topside 140b. Correspondingly, the push bar 142 can be formed as a generally elongated structure with a pair of chamfered edges 142a (or beveled, rounded, etc.) and a flat underside 142b. During assembly, the chamfered edges 142a contact and displace the lock tabs 140 via the angled sidewall 140a to enable the push bar 142 to pass therebetween. Once the push bar 142 is past the lock tabs 140, and with reference to FIG. 1f, the lock tabs 140 return to their default position, and the flat topside 140b abuts the flat underside 142b, thus securing it in place.

In the illustrated embodiment, each resilient leg 132 extends between the lead-in portion 126 and the head portion 106a and includes a first, lower segment 132a (e.g., a first linear segment) and a second, upper segment 132b (e.g., a second linear segment). The lower segment 132a is resiliently coupled (e.g., configured to flex or pivot) at a first end to the lead-in portion 126 via a first hinge 130a, and the upper segment 132b is resiliently coupled at a first end to the head portion 106a at the linear standoffs 136 via a second hinge 130b. The second ends of the upper and lower segments 132b, 132a are resiliently joined together via a third hinge 130c. One or more of the hinges 130a, 130b, and 130c may be living hinges integrally formed with the resilient legs 132 to permit elastic flexure.

When the fastener 106 is pressed downward in the direction of arrow 144 (e.g., via the head portion 106a), the resilient legs 132 flex about the third hinge 130c relative to the head portion 106a and the lead-in portion 126, causing the upper and lower segments 132b, 132a to move toward one another in a folding or collapsing motion until they are approximately parallel or at a small acute angle. In this manner, the resilient legs 132 facilitate controlled relative movement between the head portion 106a and the retention portion 106b along the center axis 110.

When assembled, the pair of wings 108 is positioned between the first component 102 and second component 104 as illustrated in FIG. 1c. In some examples, the fastener 106 may include a seal to mitigate dust, dirt, and/or moisture penetration through the opening 118. The seal may be embodied as a ring (e.g., an annular structure) and fabricated from foam material, thermoplastic, rubber, etc. For example, the seal can be over molded onto a portion of the fastener 106 or a seal can be configured to fit over the distal end of the fastener 106 to surround a portion of the fastener 106 (e.g., adjacent the pair of wings 108) between the first component 102 and the second component 104. In some examples, the fastener 106 may include additional features, such as ribs to mitigate noise and/or rattle between the first and second components 102, 104.

The components and/or features of the fastener 106 may be formed as a unitary structure. While it is contemplated that the fastener 106 would be manufactured as an integral component via a plastic injection molding process, other materials and/or processes are contemplated, such as additive manufacturing techniques. Using additive manufacturing techniques, components can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the fastener 106 may be fabricated with the first component 102 using material extrusion (e.g., fused deposition modeling (FDM)), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the first component 102 and the fastener 106 may be formed or otherwise fabricated at different resolutions during a printing operation. For example, the fastener 106 portion may be printed at a higher resolution than that of the first component 102 or vice versa as needed for a particular application.

In some examples, the first component 102 and the fastener 106 may be an integral printed thermoplastic material component. While it is contemplated that the first component 102 and the fastener 106 could be formed during the same printing session (i.e., printed during the same printing operation), it is possible that the fastener 106 may be printed onto a preexisting first component 102. For example, the first component 102 may be printed with one or more landmark structures (e.g., a protrusion or a recess) during a first session that can be located and filled and/or surrounded with material during a second session to form the fastener 106.

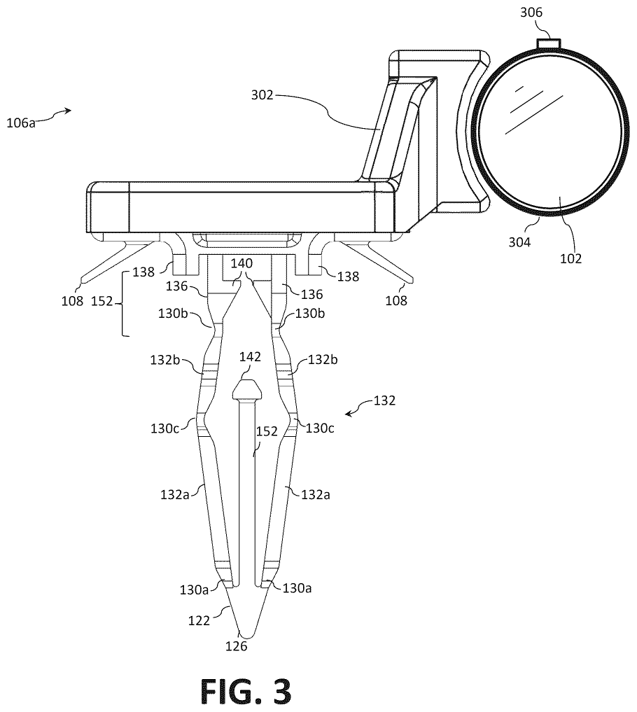

While the fastener 106 has been generally described as having a head portion 106a configured to couple with a first component 102 configure as a panel (e.g., via a doghouse), the retention portion 106b may also be utilized in alternative applications. For example, retention portion 106b can be incorporated into a retainer, routing clip, or other fastener, such as the example routing clip 300 illustrated in FIG. 3.

In this embodiment, the head portion 106a of the routing clip 300 includes a payload portion 302 that interfaces with the first component 102—shown here as a tube, which may represent brake lines, fuel lines, electrical cables, pipes, or other tubular or elongated structures. A strap opening is formed through the payload portion 302, allowing a strap 304 to be threaded through it. The strap 304 is looped around the second component 110, and its free ends are secured using a strap fastener 306. Suitable strap fasteners may include ratcheting mechanisms, latches, snaps, clips, hook-and-loop fasteners, or cable ties (e.g., zip ties).

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A fastener for coupling a first component to a second component having an opening, the fastener comprising:
a head portion configured to couple with the first component, the head portion including a pair of lock tabs, each lock tab having a sloped sidewall;
a lead-in portion configured for insertion through the opening;
a shank extending from the lead-in portion;
a push bar coupled to the shank, the push bar having at least one chamfered edge; and
a pair of resilient legs extending between the head portion and the lead-in portion, the resilient legs being configured to compress into a deflected state as the lead-in portion passes through the opening;
wherein the at least one chamfered edge of the push bar is configured to engage the sloped sidewall of at least one lock tab to allow the push bar to pass between the lock tabs during assembly, and
wherein the lock tabs are configured to capture the push bar after passage between the pair of lock tabs, thereby securing the resilient legs in the deflected state.

2. A fastener for coupling a first component to a second component having an opening, the fastener comprising:
a head portion configured to couple with the first component, the head portion including a pair of lock tabs;
a lead-in portion configured for insertion through the opening;
a push bar coupled to a shank extending from the lead-in portion; and
a pair of resilient legs extending between the head portion and the lead-in portion, the resilient legs being configured to compress into a deflected state as the lead-in portion passes through the opening;
wherein the lock tabs are configured to capture the push bar after insertion, thereby securing the resilient legs in the deflected state.

3. The fastener of claim 2, wherein the push bar comprises an elongated structure oriented substantially perpendicular to the shank.

4. The fastener of claim 2, wherein the push bar comprises an elongated structure having at least one chamfered edge along its length, the chamfered edge being configured to engage at least one of the lock tabs during assembly.

5. The fastener of claim 2, wherein the push bar comprises an elongated structure having a pair of chamfered edges along its length, the chamfered edges being configured to engage at least one of the lock tabs during assembly.

6. The fastener of claim 2, wherein each of the lock tabs comprises a sloped sidewall configured to engage the push bar during assembly.

7. The fastener of claim 2, wherein the lock tabs are offset relative to one another.

8. The fastener of claim 2, wherein each of the resilient legs comprises a first segment coupled to a second segment by a hinge.

9. A fastener for coupling a first component to a second component having an opening, the fastener comprising:
a head portion configured to couple with the first component, the head portion including a first lock feature;
a lead-in portion configured for insertion through the opening;
a second lock feature coupled to the lead-in portion; and
a pair of resilient legs extending between the head portion and the lead-in portion, the resilient legs being configured to compress into a deflected state as the lead-in portion passes through the opening;
wherein the second lock feature is configured to couple with the first lock feature to secure the resilient legs in the deflected state.

10. The fastener of claim 9, wherein the second lock feature comprises a push bar.

11. The fastener of claim 10, wherein the push bar is coupled to the lead-in portion via a shank.

12. The fastener of claim 11, wherein the push bar comprises an elongated structure oriented substantially perpendicular to the shank.

13. The fastener of claim 10, wherein the push bar is configured to engage the opening to fix the lead-in portion relative to the second component during installation while the resilient legs continue to compress.

14. The fastener of claim 9, wherein the first lock feature comprises one or more lock tabs.

15. The fastener of claim 14, wherein each of the one or more lock tabs is coupled to the head portion via a standoff.

16. The fastener of claim 9, wherein the first lock feature comprises a pair of lock tabs.

17. The fastener of claim 16, wherein each of the pair of lock tabs is offset relative to one another.

18. The fastener of claim 9, wherein each of the pair of resilient legs comprises a first segment coupled to a second segment via a hinge.

19. The fastener of claim 18, wherein the resilient legs are configured, when installed, to press against the first component to generate a spring force that maintains compression.

20. The fastener of claim 9, wherein the head portion is configured to couple with the first component via a doghouse feature.
